(19) United States
(12) Patent Application Publication
(10) Pub. No.: US 2004/0207212 A1
(43) Pub. Date: Oct. 21, 2004

(54) Catches

(75) Inventor: Glen William Wallis, Burton-on-Trent (GB)

Correspondence Address: MICHAEL BEST & FRIEDRICH, LLP, 100 E WISCONSIN AVENUE, MILWAUKEE, WI, 53202, US

(73) Assignee: Heywood Williams Components Limited, West Yorkshire (GB)

(21) Appl. No.: 10/805,675

(22) Filed: Mar. 19, 2004

(30) Foreign Application Priority Data
Mar. 21, 2003 (GB) 0306522.4

(51) Int. Cl. E05C 3/04

(52) U.S. Cl. 292/241

(57) ABSTRACT

A catch is provided for a window, the catch comprising a striker member 10 for attachment to a first window component and attached member 11 for attachment to a second window member which is movable with respect to the first window member, the catch comprising at least one bolt member which can be shot into locking engagement with the striker member 10 by means of a manually rotatable lever 21. A catch member according to the invention provides greater security than known window catches.

The Invention relates to a catch and particularly to a window catch.

Various types of catch are known, to secure a vertically sliding window, for example a sash window, either with respect to a fixed member such as a surrounding frame, or with respect to another window. For example, it is common practice to have an upper window which can slide downwardly and a lower window which can slide upwardly. If both windows are closed with respect to a surrounding frame, and then the two windows are secured together with a catch, this makes them no more secure against unauthorised entry from outside.

Main catches include a threaded member on one window which can be screwed into a threaded boss on the other window, or a snib, for example in the form of a projection on one window which can be moved into engagement with a recess on the other window.

The invention seeks to provide a window catch which provides greater security than known window catches.

The invention provides a catch for a window, the catch comprising a striker member for attachment to a first window component, and a catch member arranged for attachment to a second window member which is movable with respect to the first window member, the catch comprising at least one bolt member which can be shot into locking engagement with the striker member by means of a rotatable lever.

Preferably, there are at least two shoot bolts, projecting from a shoot bolt carrier, rotation of the lever bringing about rotation of a cam which acts on the shoot bolt carrier.

The (or each) bolt may be arranged to project into a socket or aperture on the striker member to bring about locking.

The (or each) bolt may be spring loaded, and have a tapered nose, so that when one of the window components is moved into a closed position with relation to the other window component, the shoot bolts snap into position in the striker member.

The lever may be connected to the cam via the barrel of a cylinder lock so that when the lever is in the locking position, the lever can be locked in position by means of a key.

The lever may be manually rotatable.

The invention includes a window when fitted with a catch according to the invention.

By way of example, a specific embodiment of the invention will now be described, with reference to the accompanying drawings, in which:

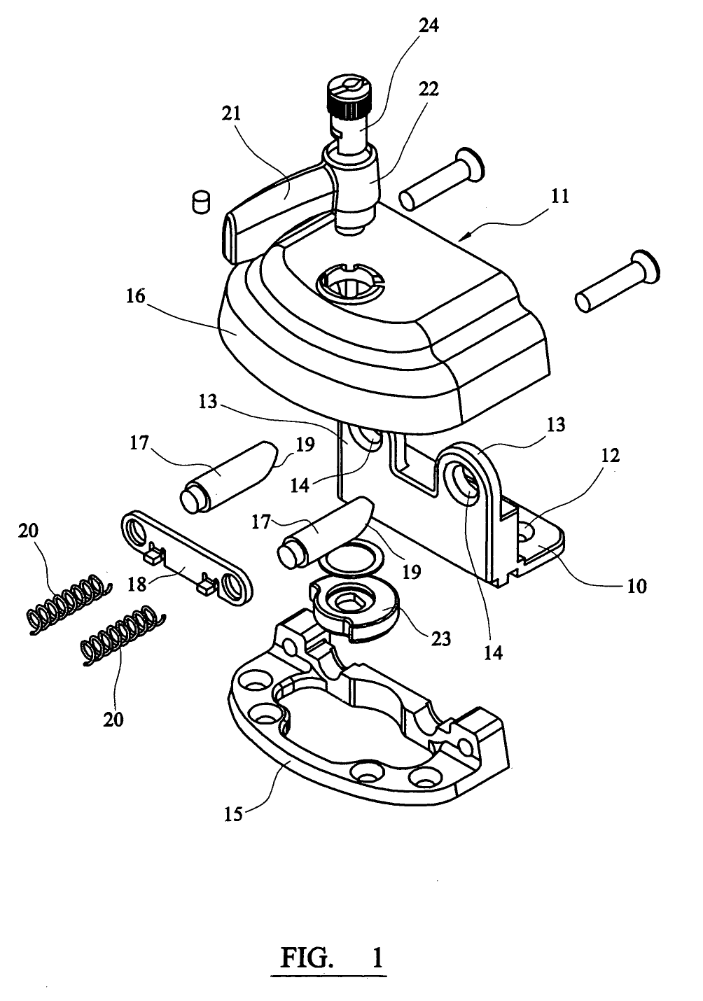

FIG. 1 is an exploded perspective view of an embodiment of window catch according to the invention; and

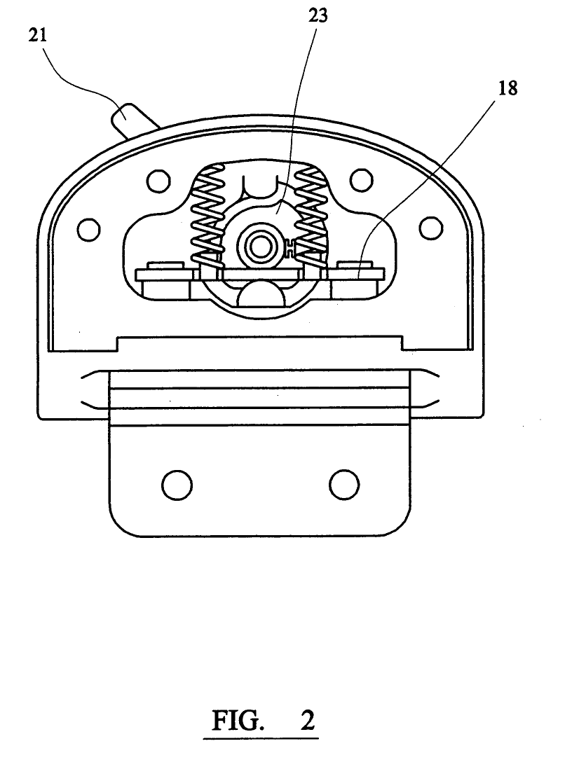

FIG. 2 is a plan view of part of the catch of FIG. 1, showing a cam and a shoot bolt carrier.

The catch shown in the figures comprises a striker member 10 and a catch assembly 11.

The striker member 10 comprises a plate with screw holes 12 therein, which in use is screwed to the frame of a lower window component, for example a lower part of a sash window. Two lugs 13 project upwardly from the plate 12 and each lug has a hole 14 therein.

The catch assembly Is secured to the frame of a second window component, for example the upper part of the sash window. The catch assembly 11 comprises a base 15 and an upper cover 16. Mounted for movement on the base are two shoot bolts 17 which are fastened to a shoot bolt carrier 18. Each shoot bolt has a tapered nose 19.

The shoot bolt carrier 17 is urged by compression springs 20 towards the lugs 13. Thus when the two window components are moved into position to close the sash window, the tapered nose 19 ride over the lugs 13 and the shoot bolts snap into the holes 14.

To retract the shoot bolts against the action of the springs 20, a lever 21 is swung to one side, rotating a column 22 which is connected to a cam 23 within the catch assembly. As best shown in FIG. 2, the cam 23 lies adjacent to the shoot bolt carrier 18 and rotation of the cam brings about the desired movement of the shoot bolt carrier.

The lever 21 can also be used to positively move the shoot bolts into their locking position.

If desired, the column 22 may be fitted with a key operated cylinder lock 24 so that once the shoot bolts have been engaged, the lever 21 can be locked so that it can no longer be moved manually thus giving an even greater degree of security.

Although the catch according to the invention has been designed primarily to lock together two window components, for example two parts of a conventional, vertically movable sash window, it will be appreciated that the catch can of course be utilised to lock together any two adjacent components, where at least one of the components can move with respect to the other.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A catch for a window, the catch comprising a striker member for attachment to a first window component, and a catch member arranged for attachment to a second window member which is movable with respect to the first window member, the catch comprising at least one bolt member which can be shot into locking engagement with the striker member by means of a rotatable lever.

2. A catch as claimed in claim 1, in which there are at least two shoot bolts, projecting from a shoot bolt carrier, rotation of the lever bringing about rotation of a cam which acts on the shoot bolt carrier.

3. A catch as claimed in claim 1 or claim 2, in which the (or each) bolt is arranged to project into a socket or aperture on the striker member to bring about locking.

4. A catch as claimed in any one of the preceding claims, in which the (or each) bolt is sprung loaded, and has a tapered nose, so that when one of the window components is moved into a closed position with relation to the other window component, the shoot bolts snap into position in the striker member.

5. A catch as claimed in claim 2, or either of claims 3 or 4 when dependent on claim 2, in which the lever is connected to the cam via the barrel of a cylinder lock so that when the lever is in the locking position, the lever can be locked in position by means of a key.

6. A catch as claimed in any one of claims 1 to 5, in which the lever is manually rotatable.

7. A catch substantially as hereinbefore described with reference to the accompanying drawings.

8. A window when fitted with a catch as claimed in any one of claims 1 to 6.
